(19) United States
(12) Patent Application Publication
(10) Pub. No.: US 2003/0144754 A1
(43) Pub. Date: Jul. 31, 2003

(54) Statistical golf program

(76) Inventor: Audra M. Butts, Indianapolis, IN (US)

Correspondence Address: Robert F. Meyer, Esq., 6116 W. 29th Pl., Speedway, IN, 46224, US

(21) Appl. No.: 10/058,875

(22) Filed: Jan. 30, 2002

(51) Int. Cl. G06F 155/00

(52) U.S. Cl. 700/92

(57) ABSTRACT

A computer golf program for tabulating and converting golf performance data into various quantitative golf performance. The program is particularly designed for golf matches between high school or college teams. Both individual and team golf scores and other golf performance data is provided. In team play, the team totals are calculated from the four lowest scores out of 5 players. The program is adapted to dual matches, three-way matches, and tournaments of over 3 teams in competition.

### FIELD OF THE INVENTION

The present invention relates to a statistical computer program and more particularly to such a program designed to deal with diverse conditions of golf matches.

### BACKGROUND OF THE INVENTION

In team golf events such as high school or college golf matches, it is highly desirable from a coach's standpoint to maintain individual performance data. Such data would include individual scores, the number of pars, bogeys, birdies, putts, etc. for a member of the team as well as the total team score.

It is apparent that it would be highly cumbersome and laborious to develop and maintain such records by hand. It would obviously be far better to develop a computer program to provide such records.

### OBJECT OF THE INVENTION

It is therefore an object of the present invention to provide a statistical computer program for developing and maintaining statistical data arising from golf matches.

### SUMMARY OF THE INVENTION

Generally speaking, there is provided a golf program adapted to be used in conjunction with Microsoft Excel contained in a computer to provide a tabulation of golf performance data and simultaneously converting at least a portion of the golf performance data into quantitative performance data while simultaneously displaying both the performance data and the quantitative data on a worksheet in a window of the computer.

### BRIEF DESCRIPTION OF THE DRAWINGS

FIG. 1 is a block diagram of the program structure of the present invention.

FIGS. 2 through 5 are worksheets which appear in a window of a computer of the present invention.

### DETAILED DESCRIPTION OF THE INVENTION

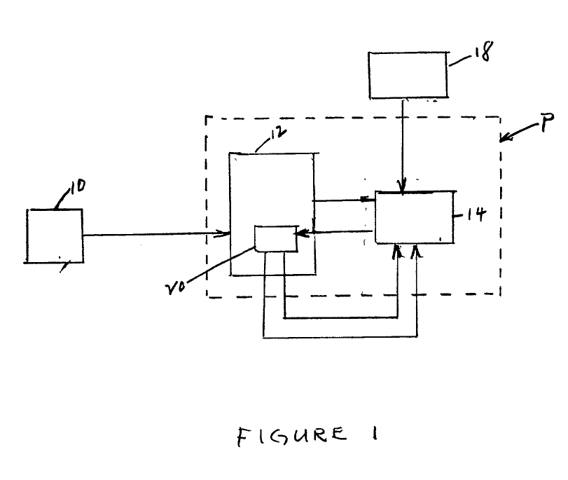

Referring to FIG. 1 there is shown a disk 10 which carries the golf program. Disk 10 is inserted into data processor 12 which contains Microsoft Excel 5.0 or higher. The Microsoft Excel software provides a worksheet(s) 14 that is shown in a window (not shown) of computer P. As will be described herein after, golf performance data is supplied to worksheet 14 by way of a keyboard 18 carried by computer P. As the performance data is tabulated on the worksheet it is simultaneously processed by formulae 20 contained in the Microsoft Excel to convert the performance data into various quantitative performance data and tabulated on worksheet 14.

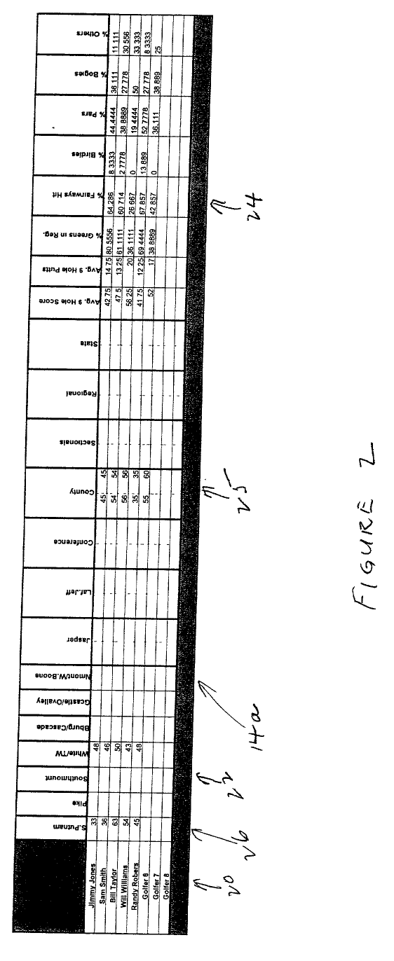

FIG. 2 represents a worksheet 14a which provides a summary for the accumulated data from a golf match, the summary being for the “home team” only. As shown, worksheet 14a includes a number of spaces 20 for listing player's names, a number of cells 22 for entering the scores of the individual players, and a number of cells 24 for listing other data for each player such as the number of birdies, pars, bogeys, greens hit in regulation, fairways driven into, and others. The worksheet also includes spaces 26 for listing the opponent being played at a given time. In the illustrative embodiment, school names such as S.Putnam, Pike, etc. are listed as well as spaces 25 for special golf meets such as county, sectional, regional or state meets.

The operation of the computer thus far can now be described with reference to worksheet 14a. The user of the computer supplies data taken from players' scorecards to the computer by way of keyboard 18, it being understood that such cards are not only used to tabulate scores but all the performances such as pars, birdies, putts, etc.

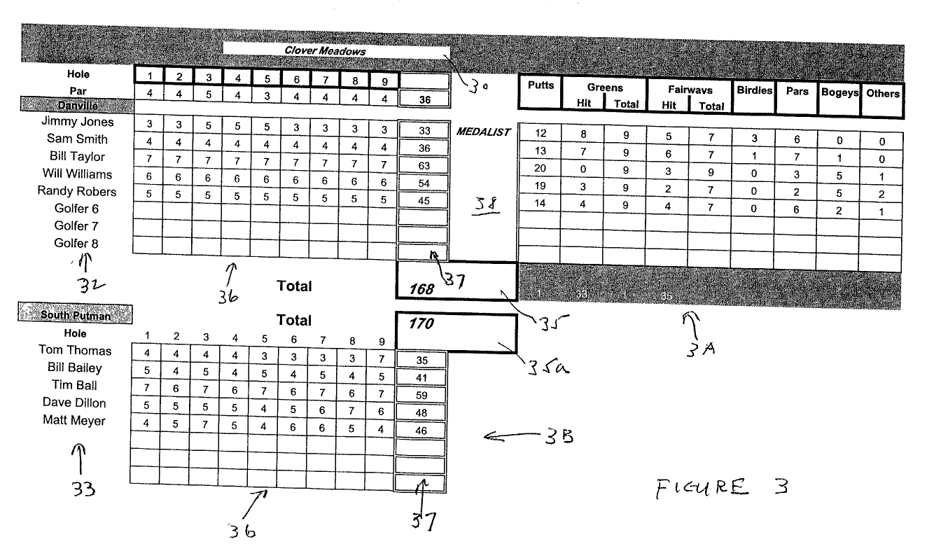

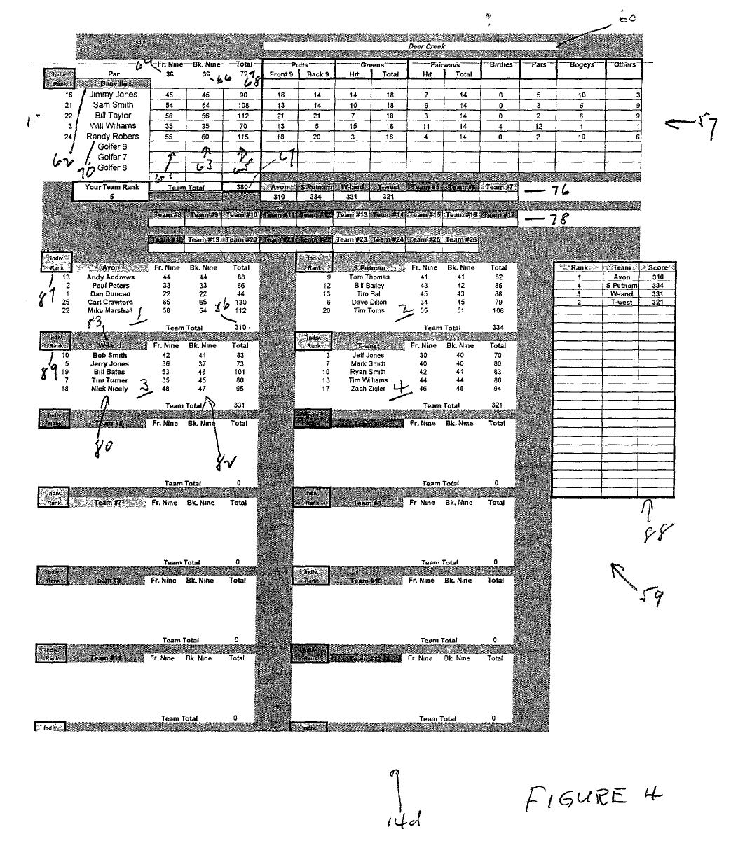

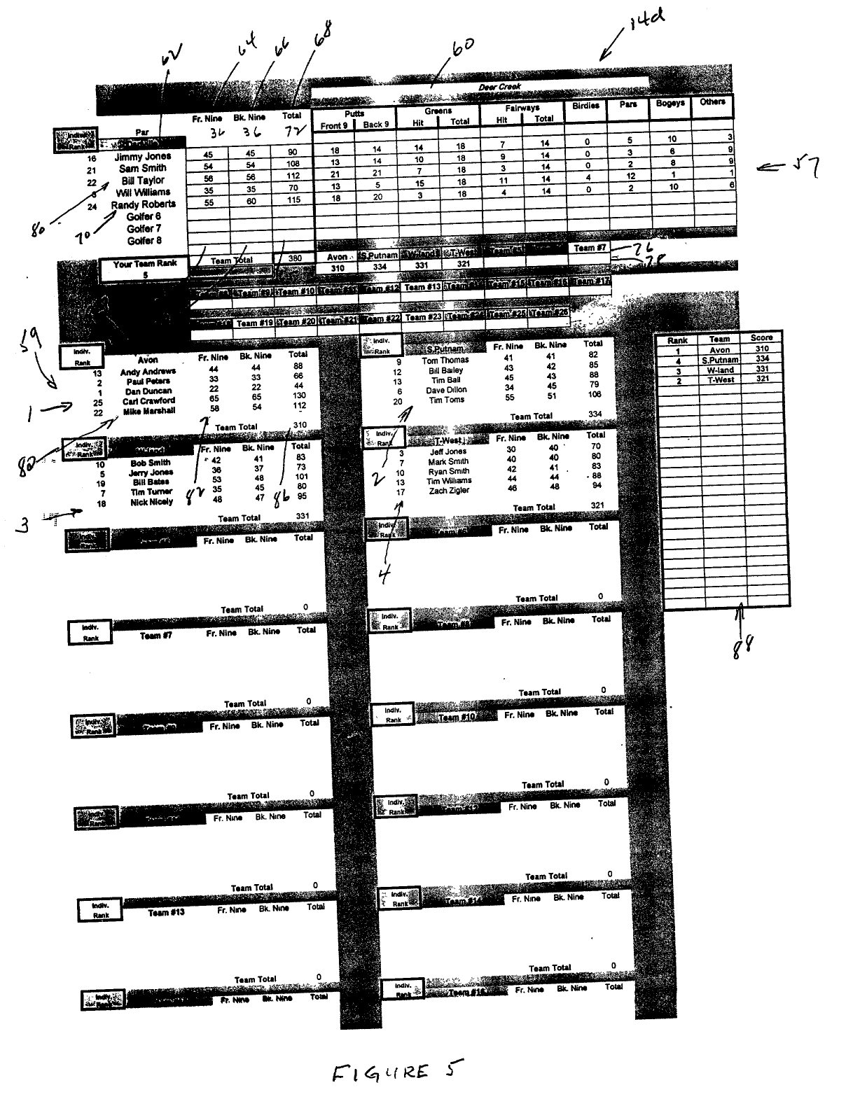

In a manner well known in the computer art, the user first opens the file, that is, the user makes all of the worksheets with the Microsoft unit available by inserting the golf program disk 10 into the computer. Regardless of whether a dual match, FIG. 3, a three way match (FIG. 4) or a tournament of more than 3 teams (FIG. 5) is being tabulated, the summary of worksheet 14a (FIG. 2) is first brought up to coincide with the type of match. As shown, the names of players for a current event are typed in spaces 20 of the summary. In the illustrative embodiment, players for 1 team, with up to spaces for 8 players is illustrated. As will be illustrated hereinafter, these names will automatically be supplied to either of the worksheets of FIGS. 3, 4 and 5 through the use of Microsoft Excel.

FIG. 3 represents a worksheet 14b used for a dual golf match between two golf teams. Worksheet 14b includes two sections, 3A and 3B. Section 3A displays data for the “home team” while section 3B displays data for the opponents of the “home team”. As previously noted the summary worksheet 14a is brought up and the players names are typed in with keyboard 18. As shown, the home team is Danville, and the opponent is S.Putnam. Worksheet 14b is then brought up with the “home team”, the opponents team, and the names of the players of the “home team”, Jones, smith, Taylor, Williams, and Roberts being automatically shown in spaces 32, while the names of Thomas, Bailey, Ball, Dillon, and Meyer are typed into spaces 33. The name of the golf course (Clover Meadows) is entered into space 30 and the hole numbers 1-9 with corresponding par for each hole are entered into spaces 39 and 39a. The hole numbers are also entered in spaces 34 of the opponents section 3B. From the scorecard of a match the pertinent data is entered. Each individual's scores are entered in cells 36 and automatically totaled in cells 37 by the formulae 20 contained in Microsoft Excel. For Jones, scores of 3,3,5, etc. and a total of 33 are entered and automatically entered in the appropriate space 22 of the Summary worksheet 14a. This process is carried through for all five players. The low individual score (Medalist) is automatically indicated in space 38; that is a score of 33.

In golf matches between high school teams as well as in a college match, it is the usual practice to eliminate the highest score of one of the five players and use only the totals of four player's score. The program of the present invention provides for this practice. The total of four of the five players of each team is calculated by Microsoft Excel (186 and 183) and recorded in spaces 35 and 35a. The high score of 54 of Williams was automatically eliminated in calculating the team total.

Referring to section 36A and player Jones, there is shown data other than scores for the “home team”. From the scorecard the user enters the number of putts (12), the number of greens hit (8) out of a possible 9, the number of fairways driven into (5) out of 7, the number of birdies (3), the number of pars (6), the number of bogeys (0), and other data such as double bogeys.

Returning now to FIG. 2 for the worksheet 14a, a summary of all the data thus far is shown by way of the formulae in Microsoft Excel. As previously noted the nine hole score of 33 for Jones has been automatically recorded as well as his score of 45 against a school named Tri-West, and scores of 45 and 45 in a county meet. In addition there is shown his calculated average score of 42.75 for the matches and county meet, his average number of putts, the percentage of greens hit in regulation, the percentage of fairways hit, and the percentage of birdies, pars, and others. The scores of the fifth player Williams have also been recorded as well as his pars, birdies, etc.

Referring now to FIG. 4, there is shown a worksheet 14c used for 3 way golf meets. The worksheet is divided into sections 4A for the “home team” data, 4B for one of the opponents, and 4C for another opponent. As in the case of FIG. 3, the course name where the meet is held is entered in space 40, the hole numbers and their respective pars are entered in space 41 and 42 and the names of the players entered in spaces 44, 46, and 48. There are also spaces 43, 45 and 47 for entry of individual scores, as well as spaces 49, 50, and 51 to enter the totals of each scores. The total for each players are, as in the case of the dual meet, calculated by the formulae 18 of Microsoft Excel, and entered in columns 49, 50, and 51. Likewise the team totals based in four of the five players, are calculated and entered in spaces 52, 53, and 54 and as in the dual meet, there is a space 55 to indicate the low score or the Medalist.

Again as in the worksheet of the dual meet, there is a section 56 for entering the performance data other than individual and team scores for the “home team”.

Referring to FIG. 5 there is shown a worksheet 14d that is useful for recording data for golf meets or tournaments involving more than 3 teams. Normally such tournaments involve 18 hole matches rather than 9 holes. This worksheet is, therefore, particularly useful for 18 hole performance data. In general, worksheet 14d includes a section 57 for the “home team” and section 59 for the other teams. The name of the golf course (Deer Creek) is entered into space 60, the name of the “home team” (Danville) is entered in space 62, and par for the course is entered in spaces 64, 66, 68. The player's names of the “home team” are entered in space 70. The names of the teams entered in the tournament are entered in spaces 76 with spaces 78 being provided for the total score for the tournament of the teams listed.

As shown, both of the nine hole scores for each player of the “home team” is entered in spaces 61 and 63 and their total is automatically calculated and entered in spaces 65 with the total team score of 380, being calculated on the basis of four players, is automatically entered in space 67. As in the cases of the dual and three way matches, the “home team” section also includes spaces for the number of putts, birdies, bogeys, and other scores.

Section 59 includes individual spaces 1,2,3,4, etc. for entering the data for the other teams. Each of such spaces includes spaces for team names 83, players names 80, their scores 82, the total of each player, as well as the team total (310) in space 86.

After all of the team scores have been entered and totaled by Microsoft Excel, the final totals are entered in space 76 and in a box 88 which indicates the team's rank, rank 1 being that of Avon at 310. The individual scores are compared by Microsoft Excel and their rank is entered in spaces 87, 89, etc.

The total score for each individual of the “home team” is simultaneously entered in the Summary of FIG. 2, as well as the number of putts, greens hit, etc. For player Bill Taylor, for example, his scores of 56 and 56 have been entered as well as a total of 112.

What is claimed is

1. A computer golf program adapted to be used in conjunction with Microsoft Excel contained in a computer to provide a tabulation of golf performance data and simultaneously converting at least at least a portion of the golf performance data into quantitative performance data while simultaneously displaying both the performance data and the quantitative data on worksheet in a window of the computer.

2. A computer golf program according to claim 1 wherein said tabulating includes recording said golf scores.

3. A computer golf program according to claim 1 wherein quantitative performance includes totals of a player's score.

4. A computer golf program according to claim 1 wherein pars, bogeys, and birdies are tabulated according to the player's scores.

5. A computer golf program according to claim 1 further including a tabulation of the number of greens hit in regulation by a player.

6. A computer golf program according to claim 1 further including a tabulation of the number of fairways driven into by a player.

7. A computer golf program according to claim 1 wherein said quantitative performance data includes totals of team scores.

8. A golf program according to claim 7 wherein said totals of team scores are calculated from all but the highest individual player's score.

9. A computer golf program according to claim 1 wherein said quantitative performance data includes data from a dual team match.

10. A computer golf program according to claim 1 wherein said quantitative performance data includes data from a three team match.

11. A computer golf program according to claim 1 wherein said quantitative data includes data from a golf match for more than 3 teams.

12. A computer golf program according to claim 1 wherein said quantitative data is taken from a tournament with more than three teams.
